(19) United States
(12) Patent Application Publication
(10) Pub. No.: US 2025/0332751 A1
(43) Pub. Date: Oct. 30, 2025

(54) SLICING BLADE ASSEMBLY FOR A FOOD PRODUCT SLICING APPARATUS

(71) Applicant: Provisur Technologies, Inc., Chicago, IL (US)

(72) Inventors: Alexander May, Waltenhofen (DE); Paul Goroll, Waltenhofen (DE)

(21) Appl. No.: 18/445,672

(22) Filed: Jul. 11, 2023

(51) Int. Cl. B26D 1/00; B26D 1/28; B26D 3/28; B26D 7/26

(52) U.S. Cl. CPC B26D 1/0006; B26D 1/28; B26D 3/28; B26D 7/26; B26D 2001/0046; B26D 2001/0053; B26D 2001/006; B26D 2210/02

(57) ABSTRACT

A slicing blade assembly is provided for a food product slicing apparatus. The slicing blade assembly includes a cutting blade having a body with a rotational axis defined by the axis of a drive shaft of the slicing apparatus and a center of gravity which is offset from the rotational axis, a blade mount plate having a blade holder which is offset from the rotational axis, and first and second pucks extending from the blade mount plate. Each puck is offset from the rotational axis and from the blade holder. The first puck extends through the body and the second puck does not extend through the body.

### FIELD OF THE INVENTION

The present disclosure generally relates to an apparatus for slicing food products and, more particularly, to improvements to an apparatus for slicing food products.

### BACKGROUND

Food product slicing machines have existed for some time and are used to slice various food products at a high speed rate. Exemplary food products include meat, such as beef, chicken, fish, pork, etc., and cheese. Various deficiencies have been identified with such food product slicing machines.

The cutting blade cuts a food product into slices with a determined thickness in high speed slicing applications. Involute cutting blades have been used for cutting in high speed slicing applications. The involute cutting blade is assembled on a blade mount, which is assembled on a driven drive shaft. The positioning of the cutting blade to the blade mount with regard to the radial direction is mainly achieved by a round holder concentric to the drive shaft which defines the rotation axis. The involute cutting blade rotates around the rotational axis. A cutting edge is formed around the rotational axis, and the radius of the cutting edge increases radially from the rotational axis in the circumferential direction. This shape allows for the cutting blade to fulfill a vertical cutting displacement over one rotation. The value of vertical displacement is determined by the lower beginning radius of the cutting edge relative to the rotational axis and the maximum radius. The spiral shape of the involute cutting blade provides a center of gravity (COG) that is not at the same position as the rotational axis. This can cause an undesirable imbalance during rotation.

### BRIEF DESCRIPTION OF THE DRAWINGS

The present application is illustrated by way of example and not limited in the accompanying figures in which like reference numerals indicate similar elements and in which:

FIG. 1 depicts a perspective view of a cutting blade having a counterweight in accordance with the present disclosure;

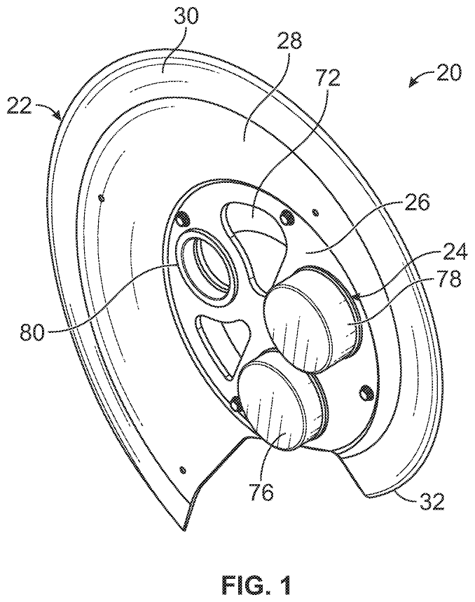

FIG. 2 depicts an exploded perspective view of the cutting blade and counterweight;

FIG. 3 depicts a first side elevation view of the cutting blade and counterweight;

FIG. 4 depicts a second side elevation view of the cutting blade and counterweight;

FIG. 5 depicts the first side elevation view of the cutting blade;

FIG. 6 depicts a perspective view of a high-speed food product slicing apparatus having the cutting blade and counterweight thereon;

FIG. 7 depicts a cross-sectional view of the high-speed food product slicing apparatus, the cutting blade and the counterweight; and

FIG. 8 depicts a perspective view of a portion of a feed assembly of the high-speed food product slicing apparatus.

### DETAILED DESCRIPTION

While the disclosure may be susceptible to embodiment in different forms, there is shown in the drawings, and herein will be described in detail, a specific embodiment with the understanding that the present disclosure is to be considered an exemplification of the principles of the disclosure, and is not intended to limit the disclosure to that as illustrated and described herein. Therefore, unless otherwise noted, features disclosed herein may be combined together to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

A slicing blade assembly 20 is provided for use with a high-speed food product slicing apparatus 120 which is used to slice food products into slices. The food products may be comprised of a wide variety of edible materials including, but not limited to meat, such as pork bellies, beef, chicken, fish, etc., and cheese. The slicing blade assembly 20 includes an involute cutting blade 22 and a counterweight 24 which is fixedly coupled to the cutting blade 22. The slicing blade assembly 20 is driven by a rotatable drive shaft 138 of the food product slicing apparatus 120 which is fixedly coupled to the counterweight 24.

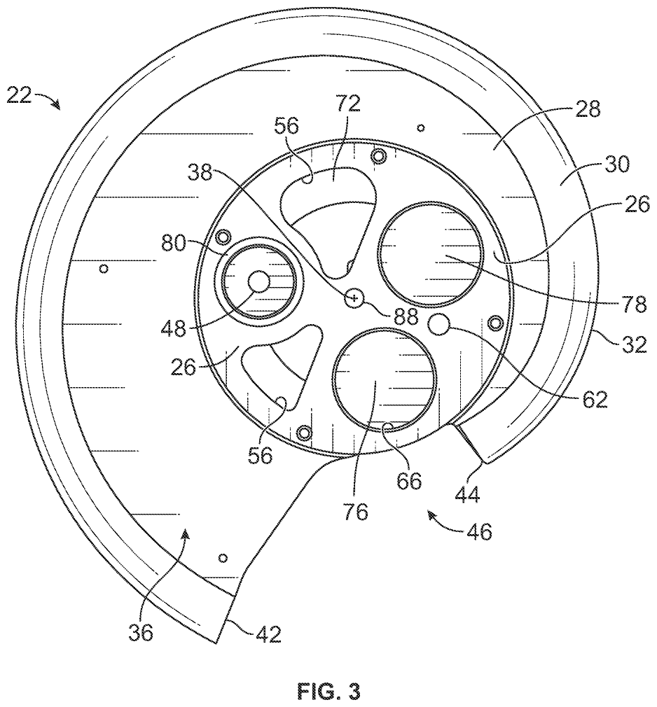

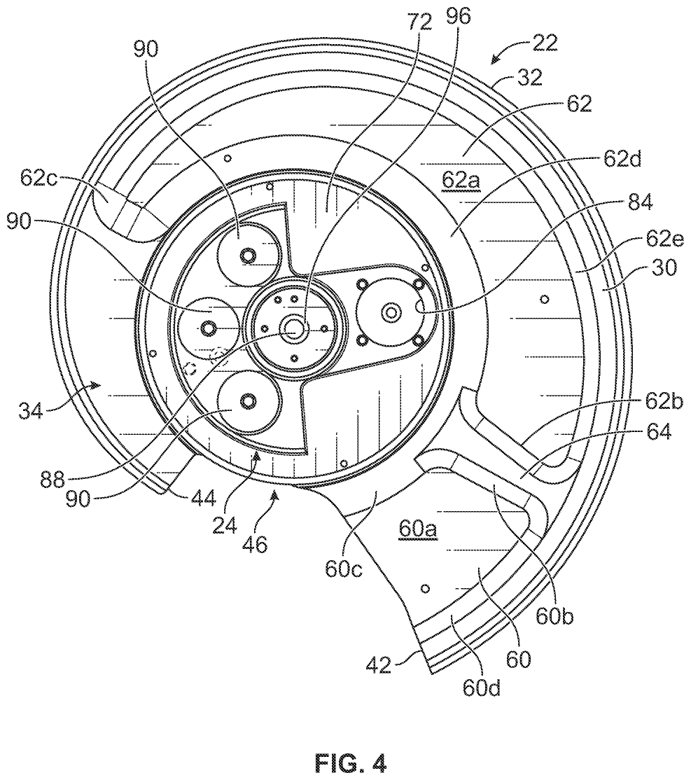

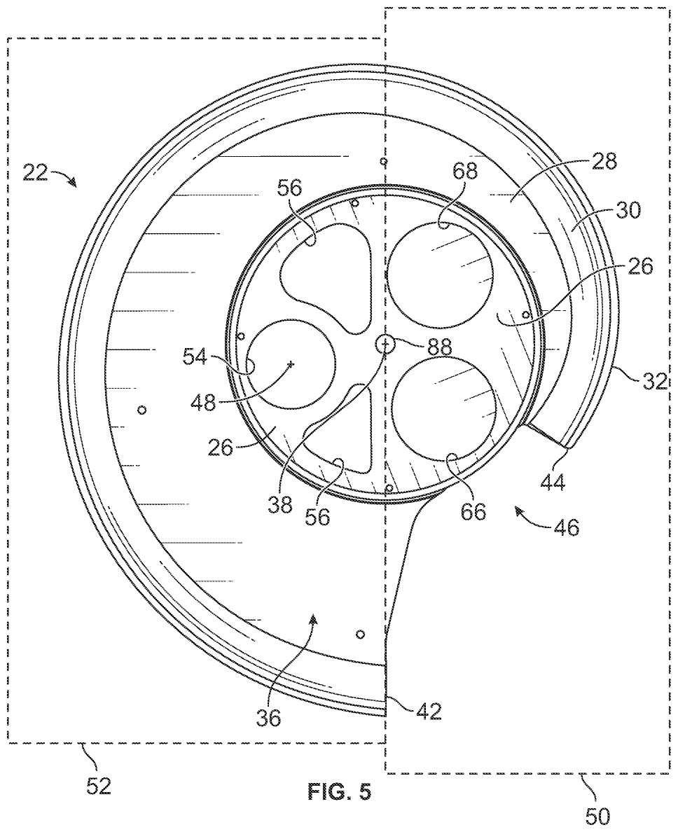

The cutting blade 22 has a body having a central planar hub portion 26, a planar intermediate portion 28 which extends radially outward from the hub portion 26, and a cutting portion 30 which extends outward from the intermediate portion 28 at an angle and tapers to a cutting edge 32. A facing surface 34, see FIG. 4, is defined on one side of the cutting blade 22, and an exit surface 36, see FIG. 3, is provided on the opposite side of the cutting blade 22. The counterweight 24 is mounted on the hub portion 26 as described herein. The cutting edge 32 is involute and extends in a spiral shape, and the radius thereof increases radially in the circumferential direction relative to a center point 38 of the spiral shape of the cutting edge 32 which is at the center of the hub portion 26. The center point 38 coincides with the axis of the drive shaft 138 of the high-speed food product slicing apparatus 120, and defines a rotational axis of the cutting blade 22. An unthreaded opening 40 is provided through the hub portion 26 around the center point 38. The cutting edge 32 starts at a first end 42 which may extend radially from the center point 38 to a second end 44 which generally extends at an angle relative to a radial line extending from the center point 38, such the ends 42, 44 are spaced apart from each other by a space 46. Because of the spiral shape of the cutting edge 32, a center of gravity (COG) 48 of the cutting blade 22 is defined, see FIG. 5, and which is eccentric to the rotational axis defined by the center point 38. The rotational axis defined by the center point 38 is provided in a first portion 50 of the cutting blade 22, and the center of gravity 48 is provided in a second portion 52 of the cutting blade 22. The first portion 50 of the cutting blade 22 has a mass that is less than the mass of the second portion of the cutting blade 22. An opening 54 is provided through the hub portion 26 in the second portion 52 of the cutting blade 22 around the center of gravity 48. The hub portion 26 may have at least one opening 56 therethrough in the second portion of cutting blade 22 to reduce the weight of the cutting blade 22.

The intermediate portion 28 has least one pocket 60, 62 formed therein extending from facing surface 34. The least one pocket 60, 62 opens into the cutting portion 30. The pocket(s) 60, 62 may be spiral-shaped. As shown, two spiral-shaped pockets 60, 62 are provided and are separated by a spoke 64. The spoke 64 can be formed to be coplanar with the hub portion 26 or can recessed below the hub portion 26. The spoke 64 extends radially outward from the center point 38. As shown, pocket 60 commences, and is open to, the first end 42, and extends around a portion of the intermediate portion 28 to the spoke 64. The pocket 60 has a planar base wall 60a, a chamfered end wall 60b which transitions to the spoke 64, a chamfered inner wall 60c which transitions to the hub portion 26, and a chamfered outer wall 60d which transitions to the cutting portion 30. Pocket 62 commences at the spoke 64 and extends around a portion of the intermediate portion 28. The pocket 62 has a planar base wall 62a, a chamfered end wall 62b which transitions to the spoke 64, an opposite chamfered end wall 62c which transitions to the angled cutting portion 30, a chamfered inner wall 62d which transitions to the hub portion 26, and a chamfered outer wall 62e which transitions to the angled cutting portion 30. The opposite surface of the intermediate portion 28 may be planar. In the embodiment as shown, pocket 62 is longer than pocket 60, however, other lengths can be provided the cutting blade 22 is balanced. As shown, pocket 62 extends approximately 180 degrees. The pockets 60, 62 can have the same depth or can be of different depths. The pockets 60, 62 and the spoke 64 can form a series of steps. The pocket(s) 60, 62 form a dish-shape. The spoke 64 stabilizes the cutting blade 22 against bending.

The hub portion 26 further has at least two openings 66, 68 therethrough for mounting the counterweight 24. Each opening 66, 68 is provided in the first portion 50 of the cutting blade 22 that has the lesser mass. Opening 66 is positioned proximate to the space 46. Opening 68 is on the opposite side of the center point 38. The openings 66, 68 may be equally radially spaced from the center point 38.

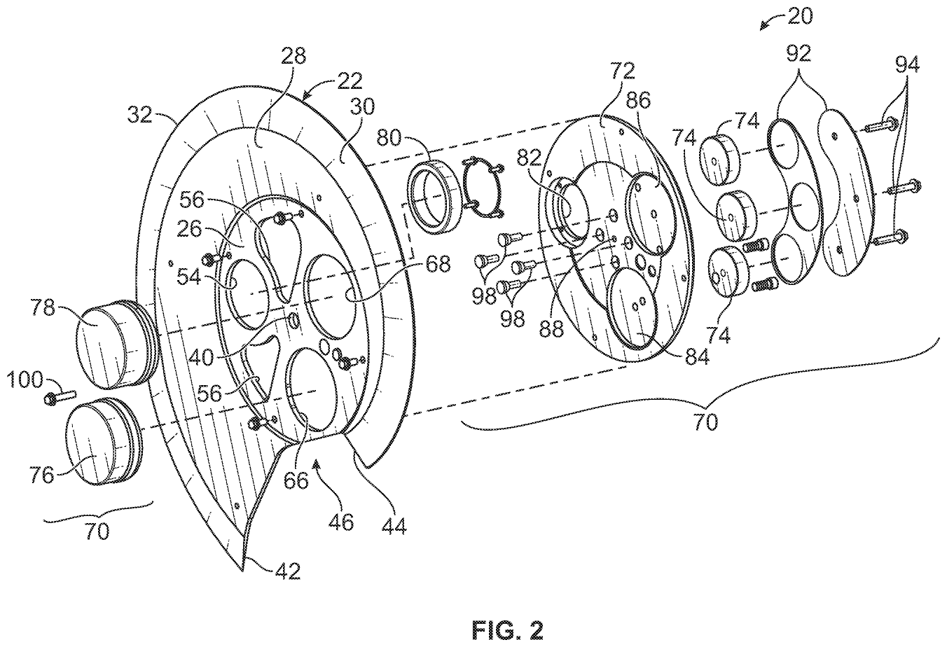

As shown in FIG. 2, the counterweight 24 includes a blade mount assembly 70 having a blade mount plate 72 coupled to the hub portion 26 of the cutting blade 22, at least one puck 74 mounted on and extending from a first face of the blade mount plate 72, at least two pucks 76, 78 mounted on and extending from a second, opposite face of the blade mount plate 72, and a blade holder 80. The blade mount plate 72 overlays the facing surface 34 of the hub portion 26, and has an opening 82 which aligns with opening 54, and recesses 84, 86 that align with openings 66, 68. In an embodiment, the blade mount plate 72 is circular and conforms in shape to the hub portion 26. The puck 76 extends through opening 66 and into recess 84, and the puck 78 extends through opening 68 and into recess 86. As such, the pucks 76, 78 are positioned on the first portion 50 of the cutting blade 22. An unthreaded opening 88 is provided at the center the blade mount plate 72 and aligns with unthreaded opening 40.

As shown, three spaced apart pucks 74 extend outwardly from the first face of the blade mount plate 72 and are positioned on the first portion 50 of the cutting blade 22. The pucks 74 are positioned on the other side of the blade mount plate 72 from the pucks 76, 78. In an embodiment, the pucks 74 are equidistantly spaced from the center of the opening 88. The pucks 74 may be mounted in recesses 90 in the first face of the blade mount plate 72 and covered by a cover 92 and fasteners 94 to secure the pucks 74 to the blade mount plate 72 as shown, or may be integrally formed with the blade mount plate 72. In this case most of the material of the blade mount 72 must be placed eccentrically from the rotational axis 38 and a center of gravity (COG) 62 of the blade mount 74 is defined, see FIG. 3, and is eccentric to the rotational axis defined by the center point 38 and on the other side of the rotational axis defined by center point 38 of the cutting blade 22. Since the blade mount 72 is limited in its radial dimension to the lower cutting edge radius, the distribution of the mass to match the given imbalance of the cutting blade 22 is also limited. A coaxial positioning of the cutting blade 22 to the blade mount 72 relative to the rotational axis reduces the possibility of eccentrically placed material to match the imbalance even more.

The blade holder 80 extends through openings 54, 82. The blade holder 80 can be formed as a separate component from the blade mount plate 72 and is affixed thereto as shown in the drawings, or can be integrally formed as a single component with the blade mount plate 72. The blade holder 80 is coupled to the cutting blade 22 by press fit, by welding, by adhesives, and/or by fasteners. In an embodiment, the blade holder 80 is ring-shaped and formed by a ring. In an embodiment, the blade holder 80 is a ring-shaped hardened bearing. The center of the blade holder opening 82 aligns with the center of gravity 48 of the cutting blade 22.

The pucks 74, 76, 78 counterbalance and equalize the greater mass of the second portion 52 of the cutting blade 22. Because the pucks 74, 76, 78 are positioned on the other side of the rotational axis defined by center point 38 of the cutting blade 22 from the center of gravity 48 of the cutting blade 22, the center of gravity of the blade mount plate 72 is offset from the center of gravity 48 of the cutting blade 22 and counterbalances the cutting blade 22. This serves to avoid an imbalance in the cutting blade 22. The center of gravity of the blade mount plate 72 is positioned exactly at the opposite side of the rotational axis defined by center point 38 relative to the center of gravity 48 of the cutting blade 22.

The drive shaft 138 of the high-speed food product slicing apparatus 120 seats within a counterbore 96 of the unthreaded opening 88 in the first face and is coupled thereto. The drive shaft 138 is fixedly coupled to the blade mount plate 72 by a plurality of unthreaded pins 98 which extend through the blade mount plate 72 and into blind openings in the drive shaft 138. As shown, four equidistantly spaced pins 98 are provided. A threaded fastener 100 is threadedly attached through the unthreaded opening 40 through the hub portion 26, through the unthreaded opening 88 through the blade mount plate 72 and threadedly engages with a threaded bore of the drive shaft 138.

Since the center of gravity 48 of the cutting blade 22 is offset from the rotational axis defined by center point 38, a rotation causes a centrifugal force from the rotational axis defined by center point 38 into the direction of the center of gravity 48. Since the blade holder 80 is positioned at the center of gravity 48 and provides the mount for the blade mount plate 72, the centrifugal force acts on the blade holder 80 and into the blade mount plate 72. The centrifugal force acts slightly above the face of the blade mount plate 72 causing a torque and a bending displacement of the blade mount plate 72. This displacement acts into the opposite direction than the bending displacement of the cutting edge 32 caused by the centrifugal force. The bending displacement can be compensated in this way, what lowers the appearing flatness differences between the first and second ends 42, 44 of the cutting edge 32 of the involute cutting blade 22. As a result, a more constant gap difference between cutting edge 32 and a shear bar 132 of the of the high-speed food product slicing apparatus 120 is provided over the whole turn of the cutting blade 22 and improves the slice quality. The dish-shape formed by the pocket(s) 60, 62 flattens under the centrifugal force.

The counterweight 24 works in concert with the pocket(s) 60, 62 to balance the cutting blade 22.

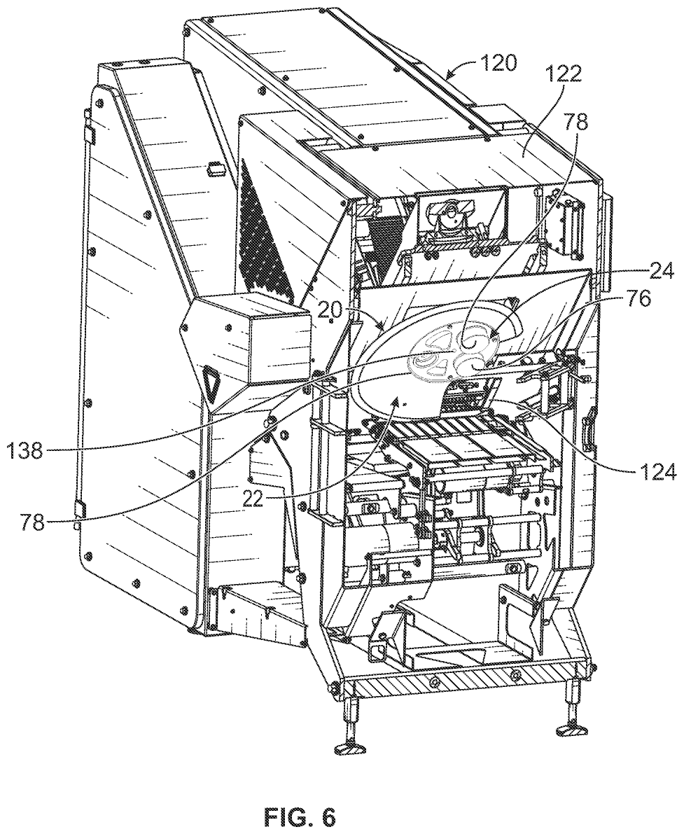

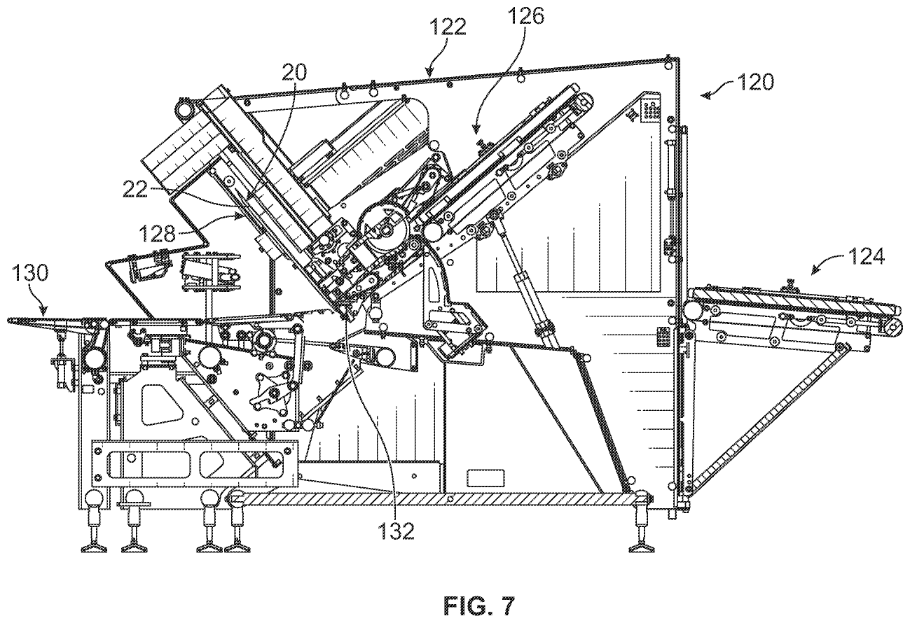

An example of the food product slicing apparatus 120 is shown in FIGS. 6 and 7. The food product slicing apparatus 120 includes a main frame 122, a load assembly 124 mounted on the main frame 122, a feed assembly 126 mounted on the main frame 122 downstream of the load assembly 124, a slicing assembly 128 mounted on the main frame 122 downstream of the feed assembly 126, and an output assembly 130 mounted on the main frame 122 downstream of the slicing assembly 128. The food product slicing apparatus 120 further includes a control system (not shown) configured to control operation of the components of the food product slicing apparatus 120. The main frame 122 supports the load assembly 124, the feed assembly 126, the slicing assembly 128, and the output assembly 130 on a ground surface and includes various mechanisms and power systems for powering the food product slicing apparatus 120. The load assembly 124 and the feed assembly 126 are configured to support and handle the food products and to move the food products to the slicing assembly 128. The sliced food product from the slicing assembly 128 is supported on the output assembly 130, which may be a conveyor, in stacks or in shingles and moved away from the slicing assembly 128. The control system includes all the necessary hardware and software to perform all of the operations and functions of the food product slicing apparatus 120. The control system may be mounted on the main frame 122 or may be remote from the main frame 122.

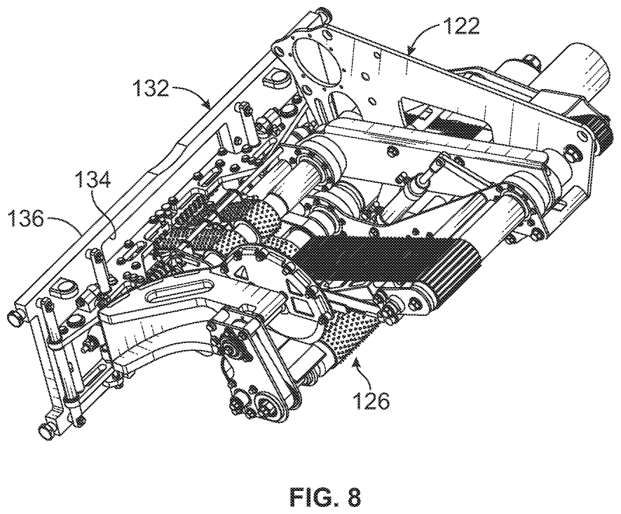

The slicing blade assembly 20 is part of the slicing assembly 128. The slicing assembly 128 further include the shear bar 132, see FIG. 8, attached to the frame 122, and which is proximate to the cutting blade 22. The shear bar 132 has an aperture 134 through which the food product passes from the feed assembly 126 prior to being cut by the rotating cutting blade 22. The shear bar 132 has a planar exit surface 136 which faces the facing surface 34 of the cutting blade 22. As the food product passes between the shear bar 132 and the cutting blade 22, the food product is cut into slices by the rotating cutting blade 22.

The food product slicing apparatus 20 may form part of a line of food processing equipment which contains other pieces of equipment, such as for example, a conventional packaging assembly, a conventional labeling assembly, etc.

While a particular embodiment is illustrated in and described with respect to the drawings, it is envisioned that those skilled in the art may devise various modifications without departing from the spirit and scope of the appended claims. It will therefore be appreciated that the scope of the disclosure and the appended claims is not limited to the specific embodiment illustrated in and discussed with respect to the drawings and that modifications and other embodiments are intended to be included within the scope of the disclosure and appended drawings. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure and the appended claims.

1. A rotatably drivable slicing blade assembly for a food product slicing apparatus, the slicing blade assembly being fixed to a rotatable drive shaft which is rotatable around an axis, the slicing blade assembly comprising:
a cutting blade comprising body having a facing surface and an opposite exit surface, the body having a rotational axis defined by the axis of the drive shaft and a center of gravity which is offset from the rotational axis, a cutting edge extending in a spiral shape around the rotational axis, and a blade holder opening through the body which is offset from the rotational axis and offset from the cutting edge;
a blade mount plate attached to the facing surface of the cutting blade and configured to be mounted to the drive shaft, the blade mount plate having a blade holder extending therefrom and offset from the rotational axis of the cutting blade, the blade holder being coupled to the body through the blade holder opening;
a first puck extending from a first side of the blade mount plate and through a puck mounting aperture in the body, the first puck being positioned offset from the rotational axis of the cutting blade and offset from the blade holder; and
a second puck extending from a second, opposite side of the blade mount plate proximate to the facing surface, the second puck being positioned offset from the rotational axis of the cutting blade, and offset from the blade holder, wherein the second puck does not extend through the body.

2. The cutting blade of claim 1, wherein the rotational axis is provided in a first portion of the body, and the blade holder opening is provided in a second portion of the body, wherein the second portion of the body has a larger mass than the first portion of the body, and wherein the first and second pucks extend from the first portion of the body.

3. The cutting blade of claim 1, further comprising a third puck extending from the first side of the blade mount plate and extending through a second puck mounting aperture in the body.

4. (canceled)

5. The cutting blade of claim 3, further comprising a fourth puck extending from the second side of the blade mount plate proximate to the facing surface, the fourth puck being positioned offset from the rotational axis of the cutting blade, and offset from the blade holder, wherein the fourth puck does not extend through the body.

6. (canceled)

7. The cutting blade of claim 1, further comprising a third puck mounted on the blade mount plate proximate to the facing surface, and a fourth puck extending from the second side of the blade mount plate, wherein the third and fourth pucks do not extend through the body.

8. The cutting blade of claim 1, wherein a center of the blade holder opening aligns with the center of gravity of the body.

9. The cutting blade of claim 1, further comprising a pocket in the facing surface which is radially offset from the blade mount plate.

10. The cutting blade of claim 9, wherein the blade mount plate engages against a planar portion of the facing surface, and a portion of the opposite surface opposite to the pocket is planar.

11. The cutting blade of claim 9, wherein the pocket is spiral shaped.

12. The cutting blade of claim 1, further comprising a first pocket in the facing surface which is radially offset from the blade mount plate, and a second pocket in the facing surface which is radially offset from the blade mount plate, wherein the pockets are separated by a spoke.

13. The cutting blade of claim 12, wherein the blade mount plate engages against a planar portion of the facing surface, and portions of the opposite surface opposite to the pockets are planar.

14. The cutting blade of claim 12, wherein each pocket is spiral shaped.

15. The cutting blade of claim 12, wherein the spoke extends radially outward from the rotational axis.

16. The cutting blade of claim 12, wherein each pocket has a chamfered end proximate to the spoke.

17. The cutting blade of claim 1, further comprising at least one weight reducing opening in the body radially offset from the rotational axis and the center of gravity of the body.

18. The cutting blade of claim 17, wherein the blade mount plate overlays the openings.

19. The cutting blade of claim 1, wherein the blade holder is a hardened bearing.

20. The cutting blade of claim 3, wherein the rotational axis is provided in a first portion of the body, and the blade holder opening is provided in a second portion of the body, wherein the second portion of the body has a larger mass than the first portion of the body, and wherein the first, second and third pucks extend from the first portion of the body.

21. The cutting blade of claim 2, wherein a center of the blade holder opening aligns with the center of gravity of the body.
